(19) United States
(12) Patent Application Publication
(10) Pub. No.: US 2010/0292954 A1
(43) Pub. Date: Nov. 18, 2010

(54) METHOD AND DEVICE FOR DETECTING ROTATING ANGLE OF REFLECTOR

(76) Inventor: CHIH-HSIUNG LIN, Jhonghe City (TW)

Correspondence Address: G. LINK CO., LTD., 2885 Sanford Ave SW #13265, Grandville, MI, 49418, US

(21) Appl. No.: 12/777,977

(22) Filed: May 11, 2010

(30) Foreign Application Priority Data
May 13, 2009 (TW) 098115934

(51) Int. Cl. G01B 11/26; G01J 3/00; G06F 15/00

(52) U.S. Cl. 702/151; 356/152.1; 356/51

(57) ABSTRACT

A device for detecting a rotating angle of a reflector includes a light emitting module, a photosensitive element, a microprocessor and a timer; the photosensitive element is used to sense time at which a beam emitted directly from the light emitting module is reflected by the rotatable reflector, and time at which a beam emitted from the light module is reflected to a target by the reflector, reflected to the reflector by the target and then reflected by the reflector, a rotating angle of the reflector is calculated by a time difference between these two times. Whereby, the accuracy of the detection of the reflector's rotating angle can be increased and the production cost of the device can be reduced.

### BACKGROUND OF THE INVENTION

1. Field of the Invention

The present invention relates to a method and device for detecting a rotating angle of a reflector, and more particularly to a photosensitive element used for sensing a time difference between the time at which light emitted directly from light emitting module and then reflected by a rotatable reflector and the time at which light is reflected by a target and then reflected by the reflector to calculate a rotating angle of the reflector.

2. Description of Related Art

There are some patents disclosing detecting a rotating angle of an object. For example, Taiwan patent publishing No. 200821939 discloses a motion detecting device for sensing rotation and inclination changes information, using an operation unit to calculate respectively a motion direction and speed of a motion detecting device relative to a detection surface, a rotating angle of the motion detecting device itself and an inclined angle of the motion detecting device itself depending respectively on a reflected light signal, a rotation and inclination angle change signal. Furthermore, for example, Taiwan patent publishing No. 200504447 discloses a color wheel rotating angle detector, using a receiver to receive a signal output from a color wheel, and judge a rotating angle of the color wheel by detecting the change of the output signal

### SUMMARY OF THE INVENTION

To increase the accuracy of the detection of a rotating angle of a reflector and reduce the production cost of an input device, the present invention is proposed.

The main object of the present invention is to provide a device and method for detecting a rotating angle of a reflector, using a photosensitive element to sense the time at which light emitted directly from a light emitting module is reflected by a rotatable reflector and the time at which light emitted from the light emitting module is reflected to the target by the rotatable reflector, reflected to the reflector by the target and then reflected by the reflector, and then uses a time difference between the two times to calculate a rotating angle of the reflector, thereby increase the accuracy of the detection of the rotating angle of the reflector.

Another object of the present invention is to provide a device and method for detecting a rotating angle of a reflector, only needing a cheaper photosensitive element, light emitting module and timer instead of an expensive image capturing module to detect the rotating angle of the reflector, thereby reducing the production cost of the device.

### BRIEF DESCRIPTION OF THE DRAWINGS

The present invention can be more fully understood by reference to the following description and accompanying drawings, in which:

FIG. 1 is a schematic view of a device for detecting a rotating angle of a reflector according to the present invention;

FIG. 2 is a graph of the detection of sensing signals by a photosensitive element according to the present invention;

FIG. 3 is a schematic view of a device for detecting a rotating angle of a rotating angle of a reflector of a first preferred embodiment according to the present invention;

FIG. 4 is a schematic view of a device for detecting a rotating angle of a reflector of a second preferred embodiment according to the present invention; and

FIG. 5 is a flow chart of a method for detecting a rotating angle of a reflector according to the present invention.

### DETAILED DESCRIPTION OF THE PREFERRED EMBODIMENTS

A device and method for detecting a rotating angle of a reflector of the present invention is to use laser light, visible light, infrared light or the like to illuminate a reflector, and use a photosensitive element to sense the time at which light is reflected by the rotatable reflector to calculate to obtain a rotating angle of the reflector.

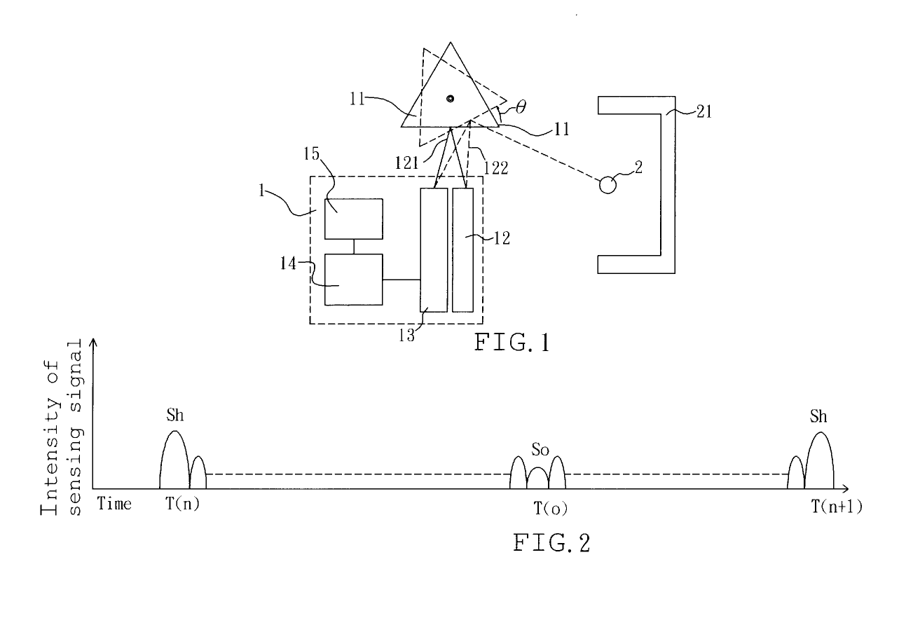

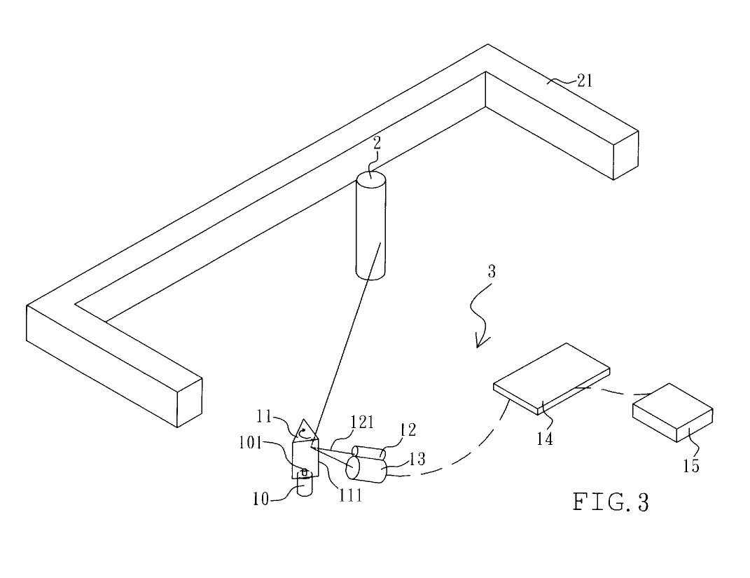

Referring to FIGS. 1, 2 and 3, a device 1 for detecting a rotating angle of a reflector of the present invention is used to detect a rotating angle of a reflector 11 driven by a motor 10, and comprises a light emitting module 12, a photosensitive element 13, a microprocessor 14 and a timer 15. A rotating shaft 101 of the motor 10 is coupled to the reflector 11, thereby driving the reflector 11 to rotate as FIG. 3 shows. The reflector 11 is disposed with m reflecting faces 111, where m is equal to 1 or a natural number larger than 1. For example, as FIG. 3 shows, the reflector 11 has three reflecting faces 111. The microprocessor 14 is in wired or wireless connection with the photosensitive element 13 and can detect sensing signals emitted from the photosensitive element 13. A beam emitted from the light emitting module 12 is reflected by the reflector 11 to illuminate a target 2 or a light reflecting or emitting structure 21. The light emitting module 12 can emit laser light, visible light or infrared light. The photosensitive element 13 may include a photo detector, a photo diode, photo receiver, a photo transistor or the like and an object capable of emitting light sensing signals. The beam reflected or emitted from the light reflecting or emitting structure 21 is weaker than the light emitted from the light emitting module 12, but stronger than the beam reflected by the target 2.

The photosensitive element 13 can sense a beam 121 emitted from the light emitting module 12 and then reflected directly by one reflecting face 111 of the first reflector 11 in sequence to obtain respectively the strongest sensing signal Sh when the first reflector 11 is rotated; the microprocessor 14 records sequentially the two times T(n), T (n+1) and etc at which the strongest sensing signals Sh are detected through a system timing clock provided by the timer 15, where a time difference (T(n+1)-T(n)) between the two adjacent times is equal to the time needed for the 1/m cycle (360 degrees/m) rotation of the reflector 11, where n, m are a natural number 1, 2, 3 . . . ; when the photosensitive element 13 senses the light emitted from the light reflecting or emitting structure 21 and then reflected by one reflecting face 111 of the first reflector 11 between the two adjacent times T(n) and T(n+1), a weaker sensing signal S0 can be obtained; the light emitted from the light reflecting or emitting structure 21 is the light emitted from the light emitting module 12, reflected to the light reflecting or emitting structure 21 by the reflector 11 and then reflected by the light reflecting or emitting module 21, or light emitted by the light reflecting or emitting structure 21 itself. When the photo sensitive element 13 senses a beam 122 emitted from the light emitting module 12, reflected to the target 2 by the reflector 11, reflected to one reflecting face 111 of the reflector 11 by the target 2 and then reflected by one light reflecting face 111 of the reflector 11 between the two adjacent times T(n) and T(n+1), the weakest sensing signal S1 can be obtained. Because the light reflected by or emitted from the light reflecting or emitting structure 21 is brighter than the light reflected from the target 2, the sensing signal S0 is stronger than the sensing signal S1. Furthermore, because the reflecting or emitting range of the light reflecting or emitting structure 21 is larger, the sensing signal S0 is continuous. The weakest sensing signal 51 can be differentiated more easily in the continuous sensing signal S0. The microprocessor 14 records the time T(0) at which the weakest sensing signal 51 is detected through the time provided by the timer 15; because the rotation of the reflector 11 is close to a uniform motion, the rotating angle of the reflector 11 as a function of the time T(0) relative to the rotating angle of the reflector 11 at the time T(n) can be calculated as (T(0)-T(n))/(T(n+1)-T(n)) multiplied by 360/m.

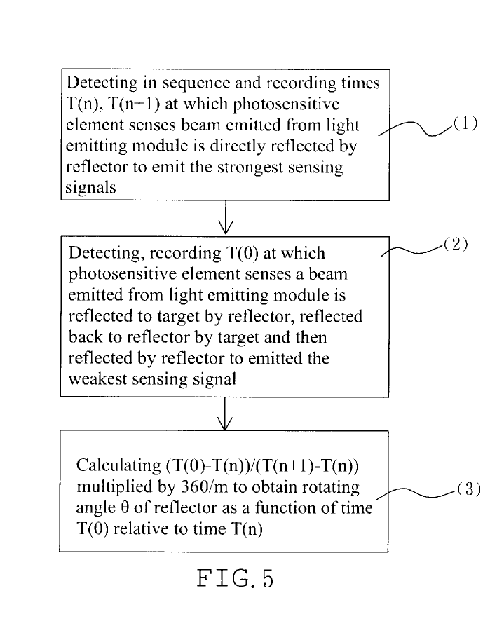

Referring to FIGS. 1, 2, 3 and 5, a method for detecting the rotating angle of a reflector according to the present invention includes the following steps:

Step 1: allowing the microprocessor 14 to record sequentially two times T(n), T(n+1) at which the two strongest sensing signal Sh emitted from the photosensitive element 13 is detected by means of the time provided by the timer 15, where the two strongest sensing signals are generated from the sensing of the beam 121 emitted from the light emitting module 12 and then reflect directly by one reflecting face 111 of the reflector 11; a time difference (T(n+1)-T(n)) of the two times is equal to the time needed for a 1/m cycle (360 degrees/m) rotation of the reflector 11;

Step 2: allowing the microprocessor 14 to record the time T(0) at which the weakest sensing signal S1 emitted from the photosensitive element 13 is detected by means of the time provided by the timer 15, where the weakest sensing signal 51 is generated from the sensing of the beam 122 emitted from the light emitting module 12, reflected to the target 2 by one reflecting face 111 of the reflector 11, reflected to one reflecting face 111 of the reflector 11 and then reflected by one reflecting face 111 of the reflector 11 between the two adjacent times T(n) and T(n+1);

Step 3: allowing the microprocessor 14 to calculate (T(0)-T(n))/(T(n+1)-T(n)) multiplied by 360/m, thereby obtaining a rotating angle θ of the reflector 11 as a function of the time T(0) relative to the time T(n).

Referring to FIGS. 1 and 3, a device 3 for detecting a rotating angle of a reflector of a first preferred embodiment according to the present invention is approximately the same as the device 1 for detecting a rotating angle of a reflector shown in FIG. 1. The light emitting module 12 and the photosensitive element 13 of the present embodiment are configured on the horizontal side of the reflector 11; the light emitting module 12 is stacked with the photosensitive element 13. The reflector 11 of the present embodiment is disposed with at least one reflecting face 111; the reflecting face 111 is parallel to a rotating shaft 101 of the motor 10.

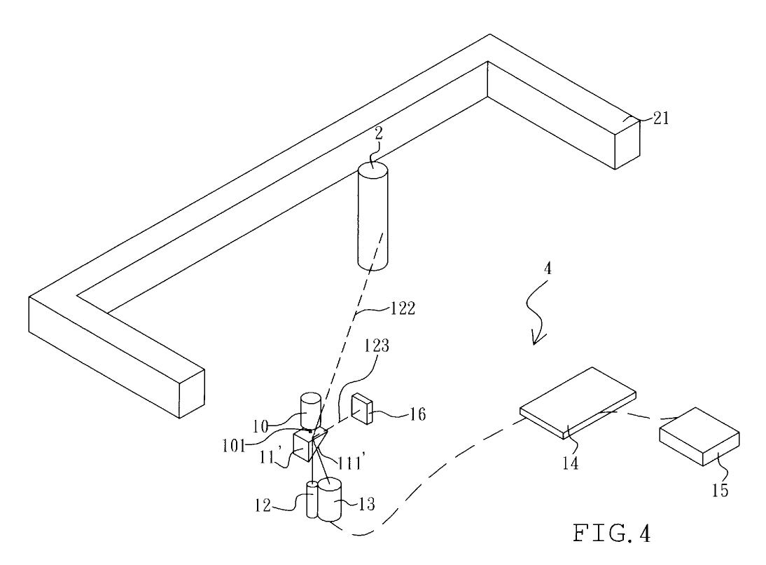

Referring to FIGS. 3 and 4, a device 4 for detecting a rotating angle of a reflector of a second preferred embodiment according to the present invention is approximately the same as the device 3 for detecting a rotating angle of a reflector shown in FIG. 3 except a mirror 16 is configured additionally and the light emitting module 12 and the photosensitive element 13 stacked together are configured on the vertical side of the reflector 11, the other structures thereof are almost the same. A reflecting face 111′ of a reflector 11′ is disposed 45 degree with the rotating shaft 101 of the motor 10. The reflector 11′ of the present embodiment may be a prism.

Because the light emitting module 12 and the photosensitive element 13 of the present embodiment are configured on the vertical side of the reflector 11′, and the reflecting face 111′ of the reflector 11′ is configured 45 degree with the light emitted from the light emitting module 12, the photosensitive element 13 cannot sense the light emitted from the light emitting module 12 and then reflected directly by the reflecting face 111′ of the reflector 11′ such that the strongest sensing signal cannot be emitted out. Therefore; the completion of the sensing must rely on a mirror 16. Because the mirror 16 has a better light reflecting effect than the target 2, the present embodiment uses the photosensitive element 13 to sense a beam 123 emitted from the light emitting module 12, reflected to the mirror 16 by the reflecting face 111′ of the reflector 11′, reflected back to the reflecting face 111′ of the reflector 11′ by the mirror 16 and then reflected by the reflecting face 111′ of the reflector 11′. Thereby obtaining the strongest sensing signal. Therefore, the steps of the method for detecting a rotating angle of a reflector of the present invention must be revised as the following:

Step 1: allowing the microprocessor 14 to record sequentially the two times T(n), T(n+1) at which the two strongest sensing signals Sh emitted from the photosensitive element 13 is detected by means of the time provided by the timer 15, where the two strongest sensing signals are generated from the sensing of the beam 123 emitted from the light emitting module 12, reflected to the mirror 16 by the reflecting face 111′ of the reflector 11′, reflected back to the reflecting face 111′ of the reflector 11′ by the mirror 16 and then reflected by the reflecting face 111′ of the reflector 11′; a time difference (T(n+1)-T(n)) of the two times is equal to the time needed for one cycle (360 degree) rotation of the reflector 11;

Step 2: allowing the microprocessor 14 to record a time T(0) at which the weakest sensing signal 51 emitted from the photosensitive element 13 is detected by means of the time provided by the timer 15, where the weakest sensing signal 51 is generated from the sensing of the beam 122 emitted from the light emitting module 12, reflected to the target 2 by one reflecting face 111 of the reflector 11′, reflected to one reflecting face 111′ of the reflector 11 and then reflected by one reflecting face 111′ of the reflector 11′ between the two adjacent times T(n) and T(n+1);

Step 3: allowing the microprocessor 14 to calculate (T(0)−T(n))/(T(n+1)−T(n)) multiplied by 360, thereby obtaining a rotating angle θ of the reflector 11 as a function of the time T(0) relative to the time T(n).

The method for detecting the rotating angles of the reflectors 11 and 11′ of the present invention includes the technical content related to the detection of the rotating angle of the reflector of the present invention in the specification besides the operating steps mentioned above; the detailed is omitted here.

The present invention does not need to rely on the rotating angles of precise, expensive stepper motors, and can also not only obtain the rotating angles of the reflector 11, 11′ but differentiate between the rotating angles of the reflectors 11, 11′ more precisely. For example, the present invention uses cheaper motors of 60 revolutions per second to drive the reflector 11 with only one reflecting face 111 to rotate such that the facilities cost thereof is cheaper. Furthermore, the present invention provides a timer 15 with a system timing clock oscillation frequency of 72 million times such that each turn of the motor is divided into 72,000,000/60=1,200,000 divisions; and 360 degrees=360*60*60=1,290,200 seconds. Therefore, the angle can be divided by each unit time interval ( 1/72 million second) is 1,290,000/1,200,000=1.08 seconds; it is very accurate. Besides, the accuracy of the angle detection can be increased if a timer 15 with a larger oscillation frequency is used.

The device and method for detecting a rotating angle of a reflector according to the present invention only uses one cheaper photosensitive element, light emitting module and timer instead of expensive camera modules to increase the detection accuracy of a rotating angle of a reflector such that the production cost of the device can be reduced.

Furthermore.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for detecting a rotating angle of a reflector, comprising the following steps:
(1) recording in sequence times T(n), T(n+1) at which the two strongest sensing signals respectively emitted from said photosensitive element are detected by means of time provided by a timer, said two strongest sensing signals being generated from one of sensing of a beam emitted from said light emitting module and then reflect directly by one reflecting face of said reflector and sensing a beam emitted from said light emitting module, reflected to a mirror by one reflecting face of said reflector, reflected back to said one reflecting face of said reflector by said mirror and then reflected by said one reflecting face of said reflector; a time difference (T(n+1)-T(n)) of said times T(n), T(n+1) being equal to time needed for a 1/m cycle rotation of said reflector, where n, m are a natural number, said first reflector has m reflecting faces;
(2) recording time T(0) at which the weakest sensing signal emitted from said photosensitive element is detected, said weakest sensing signal being generated from sensing of said beam emitted from said light emitting module, reflected to a target by said reflector, reflected to said reflector by said target and then reflected by said reflector between said two adjacent times T(n) and time T(n+1); and
(3) calculating (T(0)−T(n))/(T(n+1)−T(n)) multiplied by 360/m to obtain a rotating angle of said reflector as a function of said time T(0) relative to said time T(n).

2. The method for detecting a rotating angle of a reflector according to claim 1, wherein said step of recording in sequence times T(n), T(n+1) further comprises allowing a microprocessor to record said two times T(n), T(n+1) at which the two largest sensing signals emitted from said photosensitive element are detected by means of time provided by a timer.

3. The method for detecting a rotating angle of a reflector according to claim 2, wherein said step of recording time T(0) further comprises allowing a microprocessor to record said time T(o) at which the weakest sensing signal emitted from said photosensitive element is detected depending on said time provided by said timer.

4. The method for detecting a rotating angle of a reflector according to claim 3, wherein said step of calculating (T(0)−T(n))/(T(n+1)−T(n)) multiplied by 360/m further comprises allowing said microprocessor to calculate a value of (T(0)−T(n))/(T(n+1)−T(n)) multiplied by 360/m.

5. The method for detecting a rotating angle of a reflector according to claim 4, wherein said photosensitive element is configured on a horizontal side of said reflector;
the two strongest sensing signal are generated from the sensing of said beam emitted from said light emitting module and then reflected directly by one reflecting face of said reflector by said photosensitive element.

6. The method for detecting a rotating angle of a reflector according to claim 5, wherein said light emitting module is stacked with said photosensitive element.

7. The method for detecting a rotating angle of a reflector according to claim 4, wherein said photosensitive element is configured on a vertical side of said reflector; the two strongest sensing signal are generated from the sensing of said beam emitted from said light emitting module, reflected to said target by one reflecting face of said reflector, reflected to said one reflecting face of said reflector by said mirror and then reflected by said one reflecting face of said reflector by said photosensitive element.

8. The method for detecting a rotating angle of a reflector according to claim 7, wherein said light emitting module is stacked with said photosensitive element.

9. The method for detecting a rotating angle of a reflector according to claim 1, wherein said beam is one of laser light, visible light and infrared light.

10. A device for detecting a rotating angle of a reflector, adapted to detect a rotating of a reflector, comprising:
a light emitting module;
a photosensitive element;
a timer; and
A microprocessor, respectively in one of wired and wireless connection with said photosensitive element and said timer;
Wherein said microprocessor records in sequence times T(n), T(n+1) at which the two strongest sensing signals respectively emitted from said photosensitive element are detected by means of time provided by said timer, wherein said two strongest sensing signals are generated from one of sensing of a beam emitted from said light emitting module and then reflect directly by one reflecting face of said reflector and sensing a beam emitted from said light emitting module, reflected to a mirror by one reflecting face of said reflector, reflected back to said one reflecting face of said reflector by said mirror and then reflected by said one reflecting face of said reflector; a time difference (T(n+1)-T(n)) of said times T(n), T(n+1) is equal to time needed for a 1/m cycle rotation of said reflector, where n, m are a natural number, said first reflector has m reflecting faces; said microprocessor records time T(0) at which the weakest sensing signal emitted from said photosensitive element is detected, said weakest sensing signal is generated from sensing of said beam emitted from said light emitting module, reflected to said target by said reflector, reflected to said reflector by said target and then reflected by said reflector between said two adjacent times T(n) and time T(n+1); and said microprocessor calculates (T(0)−T(n))/(T(n+1)−T(n)) multiplied by 360/m to obtain a rotating angle of said reflector as a function of said time T(0) relative to said time T(n).

11. The device for detecting a rotating angle of a reflector according to claim 10, wherein said photosensitive element is configured on a horizontal side of said reflector; the two strongest sensing signal are generated from the sensing of said beam emitted from said light emitting module and then reflected directly by one reflecting face of said reflector by said photosensitive element.

12. The device for detecting a rotating angle of a reflector according to claim 11, wherein said light emitting module is stacked with said photosensitive element.

13. The device for detecting a rotating angle of a reflector according to claim 10, wherein said photosensitive element is configured on a vertical side of said reflector;
the two strongest sensing signal are generated from the sensing of said beam emitted from said light emitting module, reflected to said target by one reflecting face of said reflector, reflected to said one reflecting face of said reflector by said mirror and then reflected by said one reflecting face of said reflector by said photosensitive element.

14. The device for detecting a rotating angle of a reflector according to claim 13, wherein said light emitting module is stacked with said photosensitive element.

15. The device for detecting a rotating angle of a reflector according to claim 10, further comprising a light reflecting or emitting structure; said target being position between said light reflecting or emitting structure and said reflector, allowing said beam emitted from said light emitting module to be reflected to said light reflecting or emitting structure by said reflector, reflected to said reflector by said light reflecting or emitting structure, and then reflected to said photosensitive element by said reflector, or allowing a beam emitted from said reflecting or emitting structure to be projected to said reflector, and then reflected to said photosensitive element by said reflector.

16. The device for detecting a rotating angle of a reflector according to claim 15, wherein said beam is one of laser light, visible light and infrared light.

17. The device for detecting a rotating angle of a reflector according to claim 16, wherein said photosensitive is a photosensitive element chosen from one of photo detector, photo diode, photo receiver and photo and an objects capable of one of wired and wireless emission of light sensing signals.
